(19) United States
(12) Patent Application Publication
(10) Pub. No.: US 2012/0273083 A1
(43) Pub. Date: Nov. 1, 2012

(54) HOSE ASSEMBLY

(76) Inventor: TING-I LIN, Chan-Hwa City (TW)

(21) Appl. No.: 13/094,833

(22) Filed: Apr. 27, 2011

(51) Int. Cl. F16L 9/14

(52) U.S. Cl. 138/140

(57) ABSTRACT

A hose assembly includes an inner tube and an outer cover wrapping around the inner tube. The inner tube has a plurality of inner ribs disposed on an interior surface thereof, a plurality of outer ribs disposed on an exterior surface thereof and a plurality of orifices defined therethrough. The inner ribs and the outer ribs are longitudinally or spirally extended on the surfaces of the inner tube. The outer cover is sewed to form a seam. The seam includes a plurality of holes allowing water to pass through. The outer cover is made of a water-resistant material. Therefore, the water flowing in the inner tube passes through the orifices of the inner tube and the holes of the seam to water the plants.

### BACKGROUND OF THE INVENTION

1. Field of the Invention

The present invention relates generally to a hose assembly having an inner tube and an outer cover, in which the inner tube includes orifices and the outer cover includes holes allowing water to pass through.

2. The Prior Arts

A garden hose conveys water from one location to another and usually includes a nozzle or a sprayer to water plants. The user has to move in the garden and pull the hose to water plants one by one and it demands a lot of labor. When the hose is filled with water, the outlet end of the hose would move due to the water pressure. Sometimes, the hose whipping might occur which hits the plants and injures the sprouts or buds. Furthermore, using the hose to water plants consumes a lot of water. Therefore, how to reduce water consumption becomes an important issue in dry climate area.

Another method of watering plants is to provide a hose having through holes around the garden. Thus, when the water passes through the hose, the water can flow out of the holes to water the plants. By this way, the user simply turns on the faucet and a large area of the gardens can be instantly irrigated without much labor. However, one of shortcomings of this method is that the water coming out from the holes flushes soil away which causes soil erosion. Another shortcoming is that when the faucet is turned off, a suction force is generated at the holes and pebbles are sucked to clog the holes.

Still another method of watering plants, as shown in FIG. 1, is to provide an automatic sprinkling system which includes a main pipe 1 arranged on the ground, and a plurality of branch pipes 2 extended from the main pipe 1. A rotary seat 3 is disposed at free end of each branch pipe 2, and a sprinkler 4 is connected to the rotary seat 3. When water is flowed through the main pipe 1 and the branch pipe 2, the sprinkler 4 and the rotary seat 3 rotate automatically, so that water is distributed over a circular area defined with the branch pipe 2 as a center.

However, the wind would blow the water sprinkled from the sprinklers away from the target areas. Moreover, the range of water sprinkling is fixed to be circular and the water may be sprinkled on areas that do not need water so that a great amount of water is wasted. The exposed sprinklers affect the aesthetic appearance of the garden and are likely to be damaged, which needs to be replaced from time to time. Therefore, the system is costly. Furthermore, some plants are too delicate to be watered by the sprinklers and might be damaged by strong water stream from the system. Therefore, an improved watering system that can overcome the disadvantages mentioned above is needed.

### SUMMARY OF THE INVENTION

A primary objective of the present invention is to provide a hose assembly that does not waste water. Another objective of the present invention is to provide a hose assembly having reinforced strength. Still another objective of the present invention is to provide a hose assembly that can water and does not damage the plants. Yet another objective of the present invention is to provide a hose assembly, in which there is no suction force to suck pebbles to obstruct watering plants. In order to achieve the objectives, a hose assembly according to the present invention includes an inner tube and an outer cover wrapping around the inner tube. The inner tube has a plurality of inner ribs disposed on an interior surface thereof, a plurality of outer ribs disposed on an exterior surface thereof and a plurality of orifices defined therethrough. The inner ribs and the outer ribs are longitudinally or spirally extended on the surfaces of the inner tube to reinforce the inner tube.

The outer cover is sewed to form a seam. The seam includes a plurality of holes allowing water to pass through. The outer cover is made of a water-resistant material. Therefore, the water flowing in the inner tube can pass through the orifices of the inner tube and the holes of the seam to water the plants.

The water flows out of the hose assembly through the orifices of the inner tube and the holes of the outer cover. Moreover, the seam of the outer cover is disposed toward the plants that need to be watered. Thus, the water is distributed to areas that need to be watered and the hose assembly according to the present invention greatly reduces the consumption of water. The ribs of the inner tube reinforce the strength of the hose assembly. Therefore, the water still keeps flowing through the hose assembly even when the hose assembly is bent or stepped by someone. Another advantage of the present invention is that the water is seeped through the orifices and the holes. Thus, it will not generate a strong water stream to damage the delicate plants. Another advantage of the present invention is that the orifices of the inner tube are protected by the outer cover. Therefore, no pebbles would be sucked to clog the orifices.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a perspective view showing a conventional automatic sprinkling system;

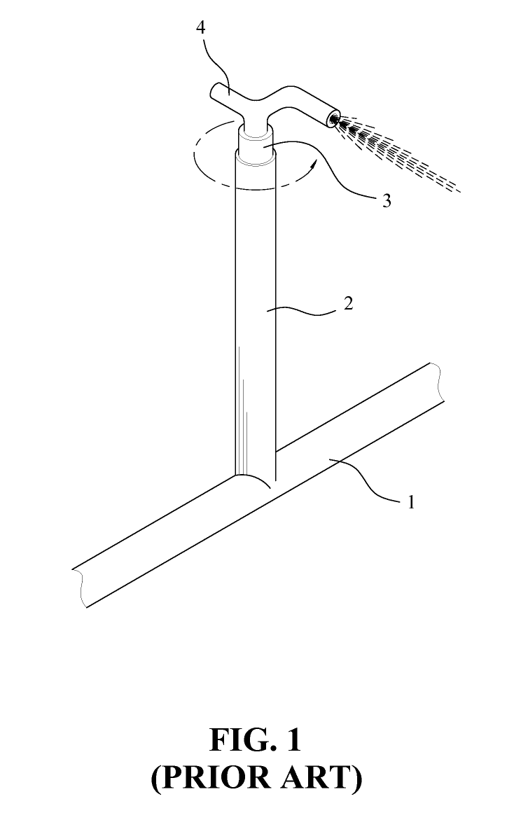

FIG. 2 is a partial perspective view showing a hose assembly in accordance with an embodiment of the present invention; and

FIG. 3 shows a use state of the hose assembly according to the present invention.

### DETAILED DESCRIPTION OF THE PREFERRED EMBODIMENT

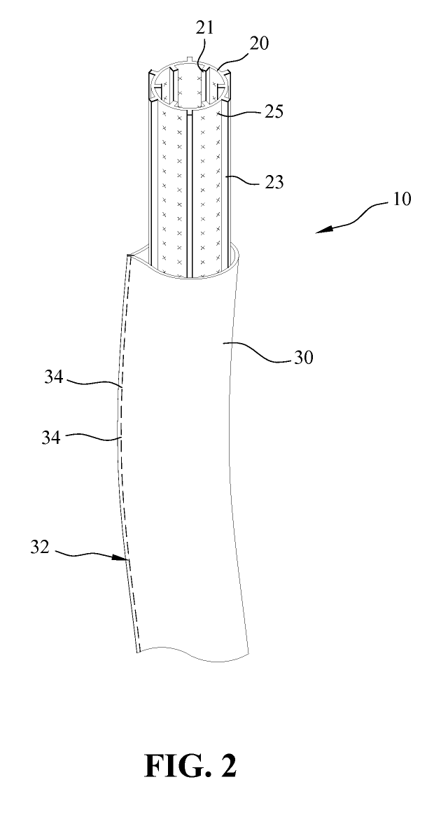

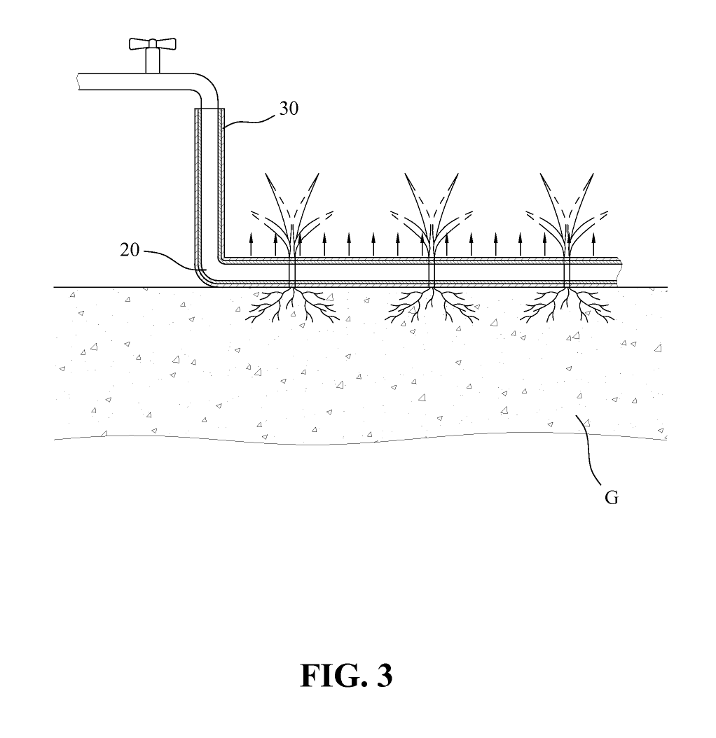

With reference to FIGS. 2 and 3, a hose assembly 10 in accordance with an embodiment of the present invention includes an inner tube 20 and an outer cover 30.

The inner tube 20 includes a plurality of inner ribs 21 disposed on an interior surface thereof and a plurality of outer ribs 23 disposed on an exterior surface thereof Both of the inner ribs 21 and outer ribs 23 extend in an axial direction of the inner tube 20. The inner ribs 21 and the outer ribs 23 reinforce the structural strength of the inner tube 20. When the inner tube 20 is bent, the inner ribs 21 prevent the inner tube from deformation and can keep the water flowing through the inner tube 20. When the inner tube 20 is pressed from outside, such as being stepped by someone, the outer ribs 23 prevent the inner tube 20 from deformation. There is no limit to the number of the inner ribs 21 and the outer ribs 23. The number of the inner ribs 21 may be the same as or different from that of the outer ribs 23. There is no limit to the locations of the inner ribs 21 and the outer ribs 23. FIG. 2 shows the inner ribs 21 is spaced away from the outer ribs 23. The inner ribs 21 may also be aligned with the outer ribs 23. There is no limit to the types of the inner ribs 21 and the outer ribs 23. In addition to the longitudinal ribs as shown in FIG. 2, the inner ribs 21 and the outer ribs 23 may spirally extend on the surfaces of the inner tube 20. A plurality of orifices 25 are defined through the inner tube 20 allowing the water to pass through the inner tube 20. There is no limit to the positions of the orifices 25 as long as the orifices 25 do not damage the ribs 21, 23. The orifices 25 may be distributed evenly or unevenly. For example, the orifices may be densely distributed at a side close the plants and sparsely distributed at a side away from the plants. The number and size of the orifices 25 may be designed depending on the needs. There is no limit to the shapes of the orifices 25, as long as they allow the predetermined amount of water to pass through. The orifice 25 may be an X-shaped slit as shown in FIG. 2. The orifice 25 may also be a V-shaped slit, a straight-line slit, a U-shaped slit, serrated slit or any shapes of slit or any shapes of through holes. There is no limit to the material of the inner tube 20, which may be a plastic flexible hose, a plastic rigid pipe, a copper pipe, or an iron pipe. Usually, the plastic inner tube 20 includes polybutylene (PB) pipe, polyethylene (PE) pipe, polyvinyl chloride (PVC) pipe, and polyvinyl acetate (EVA) pipe. The plastic inner tube is preferred because it is cheaper and easier to use. Another advantage of the plastic inner tube 20 is that the size of the orifices 25 can change due to the water pressure. The larger the water pressure is, the larger the orifices 25 are opened.

The outer cover 30 is made of water-resistant material, such as tarpaulin or canvas having a PU coating. The outer cover 30 is wrapped around the inner tube 20 and sewed together to form at least one seam 32. A plurality of holes 34 is disposed along the seam 32. Water flows in the inner tube 20, flows through the orifices 25 of the inner tube 20 and then flows out of the holes 34 of the outer cover 30. There is no limit to the types of the seam 32. The outer cover 30 may also be sewed loosely.

Referring to FIG. 3, the hose assembly 10 is installed on the ground “G” and connected with a faucet which provides water into the inner tube 20. The water flows out of the inner tube 20 and the outer cover 30 through the orifices 25 and the holes 34 of the seam 32, respectively. The seam 32 is arranged toward the plants to be watered.

Because water is flowed out of the hose assembly through the orifices 25 of the inner tube 20 and the holes 34 of the outer cover 30 and the seam 32 of the outer cover 30 is facing toward the plants that need to be watered. Thus, water only flows toward an area having plants and does not go to an area without plant. It greatly reduces the consumption of water. Another advantage of the present invention is that the ribs 21, 23 of the inner tube 20 reinforce the strength of the hose assembly 10. Therefore, even when the hose assembly is bent or stepped by someone, the water can still keep flowing through the hose assembly 10. Still another advantage of the present invention is that the water passes through the orifices 25 and the holes 34, which does not generate a strong water stream to damage delicate plants. Yet another advantage of the present invention is that the outer cover 30 covers the orifices 25 of the inner tube 20. Therefore, pebbles would not be sucked to clog the orifices 25.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A hose assembly, comprising:
an inner tube having a plurality of inner ribs disposed on an interior surface of the inner tube, a plurality of outer ribs disposed on an exterior surface of the inner tube and a plurality of orifices defined through the inner tube; and
an outer cover wrapping around the inner tube, and being sewed together to form at least one seam;
wherein water flowing in the inner tube is capable of passing through the orifices of the inner tube and the seam of the outer cover.

2. The hose assembly as claimed in claim 1, wherein the inner ribs are longitudinally or spirally extended on the interior surface of the inner tube.

3. The hose assembly as claimed in claim 1, wherein the outer ribs are longitudinally or spirally extended on the exterior surface of the inner tube.

4. The hose assembly as claimed in claim 1, wherein the orifice is an X-shaped slit.

5. The hose assembly as claimed in claim 1, wherein the orifice is a V-shaped slit.

6. The hose assembly as claimed in claim 1, wherein the orifice is one of a straight-line slit, a U-shaped slit, a serrated slit and a through hole.

7. The hose assembly as claimed in claim 1, wherein the outer cover is made of a water-resistant material.

8. The hose assembly as claimed in claim 7, wherein the outer cover is made of one of tarpaulin and canvas having a PU coating.

9. The hose assembly as claimed in claim 1, wherein a plurality of holes are defined through the outer cover and disposed along the seam and water flowing in the inner tube is capable of passing through the orifices of the inner tube and the holes of the seam of the outer cover.
